(19) United States
(12) Patent Application Publication
(10) Pub. No.: US 2016/0200496 A1
(43) Pub. Date: Jul. 14, 2016

(54) DISPENSING ASSEMBLIES AND CONTAINERS FITTED WITH THE SAME

(71) Applicant: ARAN PACKAGING AGRICULTURAL COOPERATIVE ASSOCIATION LTD., Kibbutz Nachshon (IL)

(72) Inventors: Yehuda NAHIR, Kibbutz Maoz Haim (IL); Felix MALLUL, Kibbutz Nachshon (IL); Lior MOR, Kibbutz Nachshon (IL)

(21) Appl. No.: 14/911,337

(22) PCT Filed: Aug. 12, 2014
(86) PCT No.: PCT/IL2014/050724

§ 371 Date: Feb. 10, 2016

(30) Foreign Application Priority Data
Aug. 12, 2013 (IL) 227923

(51) Int. Cl. B65D 77/06; F16L 21/00

(52) U.S. Cl. CPC B65D 77/068; F16L 21/00

(57) ABSTRACT

The disclosed subject matter pertains to dispensing assemblies and containers fitted with the same. In accordance with the disclosed subject matter there is disclosed a connector for connecting to a spout attachable to a container, the connector is configured with a spout engaging portion and a cover engaging portion, the cover engaging portion is configured to engage with a re-closable cover. One of the spout engaging portion and the spout comprising an arresting portion, and the other of the spout engaging portion and the spout comprising a first radial locking projection and a second radial locking projection, both configured for engaging with the arresting portion in a first coupling stage where the first radial locking projection detachably engages the arresting portion, and a second coupling stage where the second radial locking projection fixedly engages the arresting portion.

### TECHNOLOGICAL FIELD

The presently disclosed subject matter is in the field of dispensing assemblies and more specifically in the field of containers with dispensing assemblies suitable for flowable substances such as liquids, viscous fluids, semi-solids, powders, particulates and the like.

### PRIOR ART

Selected references considered to be relevant as background to the presently disclosed subject matter are listed below:
JP2003291991
U.S. Pat. No. 7,798,379
US2007/158295

Acknowledgement of the above references herein is not to be inferred as meaning that these are in any way relevant to the patentability of the presently disclosed subject matter.

### BACKGROUND

Dispensing assemblies for flexible containers such as Bag-in-Box are in use for different purposes, and at different configurations. Such containers are used for storing various types of flowable materials; most commonly materials relating to the food industry, though not restricted thereto, and often require an aseptic closure from early manufacture stages of the container, through the filling process of the container, until being opened by the end user.

The dispensing assembly disclosed herein is most suitable for flexible containers such as a bag of Bag-in-Box.

Examples of such dispensing assemblies and containers are described for example in JP2003291991, directed to a pour-out port assembly, thermally adhered to a bag of a Bag-in-Box, to serve as a pouring port for contents and comprises three members including a pour-out port body, an intermediate member and a screw cap.

U.S. Pat. No. 7,798,379 is directed to a fitment, for use on a flexible container, comprising a spout member having a first end and a second end and defining a passageway between the two and a plug member which is sized to be received in the passageway. The plug member also has a leading end that lies in sealing engagement with the first end of the spout member when the plug member is received in the passageway.

US2007/158295 is directed to a tamper-evidencing container and closure structures for preventing or for signaling unauthorized access to packaging. These structures provide tamper-evidencing improvements that add to the security and reliability of packaged contents.

US4353488A is directed to a connector apparatus for use with various types of disposable flexible foodstuff containers, such as polymeric bags containing soft drink syrups, of the type having a fitment attached to a wall of the container.

### GENERAL DESCRIPTION

The presently disclosed subject matter is directed, according to a first aspect thereof, to a multi stage dispensing closure for a container. Further aspects of the disclosed subject matter are directed to containers fitted with multi stage dispensing closures.

According to one aspect of the present subject matter there is disclosed a connector for connecting to a spout attachable to a container, the connector is configured with a spout engaging portion and a cover engaging portion, said cover engaging portion is configured to engage with a re-closable cover. One of said spout engaging portion and said spout comprising an arresting portion, and the other of said spout engaging portion and said spout comprising a first radial locking projection and a second radial locking projection, both configured for engaging with said arresting portion in a first coupling stage wherein the first radial locking projection detachably engages the arresting portion, and a second coupling stage wherein the second radial locking projection fixedly engages the arresting portion.

According to yet and aspect, there is disclosed a dispensing assembly attachable to a container, the dispensing assembly comprising:
a spout having a container engaging portion and a connector engaging portion, with a flow path extending between the two, the spout being configured for fixedly attaching to the container;
a connector, configured with a spout engaging portion and a cover engaging portion, said cover engaging portion is configured to engage with a re-closable cover;
a re-closable cover mounted over said connector;
one of said spout engaging portion and said spout comprising an arresting portion and the other of said spout engaging portion and said spout comprising a lateral projection and a locking member with an intermediate, middle portion extending therebetween, the locking member comprising a first radial locking projection and a second radial locking projection, configured for engaging with said arresting portion, in a first coupling stage wherein the lateral projection detachably engages the arresting portion and is displaced thereover so as to obtain contact therebetween and the middle portion such that the locking member prevents further displacement, and a second coupling stage wherein the locking member fixedly engages the arresting portion in a non openable manner, whereby the second radial locking projection is interlocked over the arresting portion; and wherein the second radial locking projection protrudes laterally beyond the first radial locking projection, and wherein the locking member protrudes laterally beyond the lateral projection.

According to another aspect of the present subject matter there is disclosed a cover assembly, comprising:
a connector for connecting to a spout attachable to a container, the connector is configured with a spout engaging portion and a cover engaging portion, said cover engaging portion is configured to engage with a re-closable cover. One of said spout engaging portion and said spout comprising an arresting portion, and the other of said spout engaging portion and said spout comprising a first radial locking projection and a second radial locking projection, both configured for engaging with said arresting portion in a first coupling stage wherein the first radial locking projection detachably engages the arresting portion, and a second coupling stage wherein the second radial locking projection fixedly engages the arresting portion; and
a re-closable cover mounted over said connector.

According to yet another aspect of the present subject matter there is disclosed a dispensing assembly attachable to a container, the dispensing assembly comprising:
a spout having a container engaging portion and a connector engaging portion, with a flow path extending between the two, the spout being configured for fixedly attaching to the container;
a connector, configured with a spout engaging portion and a cover engaging portion, said cover engaging portion is configured to engage with a re-closable cover. One of said spout engaging portion and said spout comprising an arresting portion and the other of said spout engaging portion and said spout comprising a first radial locking projection and a second radial locking projection, both configured for engaging with said arresting portion in a first coupling stage wherein the first radial locking projection detachably engages the arresting portion, and a second coupling stage wherein the second radial locking projection fixedly engages the arresting portion; and
a re-closable cover mounted over said connector.

According to yet another aspect of the present subject matter there is disclosed a container assembly, comprising:
a container having at least one wall comprising an aperture therein, the at least one wall defining a space;
a spout having a container engaging portion and a connector engaging portion with a flow path extending between the two, the spout being configured for sealingly engaging the at least one wall over said aperture, the spout being in fluid flow communication with the space defined by the at least one wall of the container;
a connector, configured with a spout engaging portion and a cover engaging portion, said cover engaging portion is configured to engage with a re-closable cover. One of said spout engaging portion and said spout comprising an arresting portion and the other of said spout engaging portion and said spout comprising a first radial locking projection and a second radial locking projection, both configured for engaging with said arresting portion in a first coupling stage wherein the first radial locking projection detachably engages the arresting portion, and a second coupling stage wherein the second radial locking projection fixedly engages the arresting portion; and
a re-closable cover mounted over said connector.

According to yet another aspect of the present subject matter there is disclosed a method of assembling a dispensing assembly to a container, said method comprising:
providing a container;
providing a spout having a container engaging portion and a connector engaging portion with a flow path extending between the two, the spout being configured for fixedly attaching to a wall of the container;
providing a connector, configured with a spout engaging portion and a cover engaging portion, said cover engaging portion is configured to engage with a re-closable cover. One of said spout engaging portion and said spout comprising an arresting portion and the other of said spout engaging portion and said spout comprising a first radial locking projection and a second radial locking projection, both configured for engaging with said arresting portion in a first coupling stage wherein the first radial locking projection detachably engages the arresting portion, and a second coupling stage wherein the second radial locking projection fixedly engages the arresting portion;
coupling the connector with the spout in a first coupling stage, wherein the first radial locking projection detachably engages, by means of interference fit, with the corresponding arresting portion, and
coupling the connector with the spout in a second coupling stage, wherein the second radial locking projection fixedly engages with the corresponding arresting portion, by displacing the second radial locking projection over the arresting portion.

Any one or more of the following features, designs and configurations can be incorporated in any one or more of the aspects of the presently disclosed subject matter, independently or in combinations thereof:
The first radial locking projection and the second radial locking projection can be coextensive (it is suggested that they extend continuously one above the other without any axial interruptions).
The first radial locking projection and the second radial locking projection can be identical or differ in dimensions and\or in shape.
The arresting portion can protrude inwardly or outwardly in the radial direction.
The first radial locking projection and the second radial locking projection can protrude inwardly or outwardly in the radial direction, in the direction opposite to the direction of the arresting portion.
The spout and the connector can have a tubular shape.
Any one or more of the first radial locking projection and\or the second radial locking projection and\or the arresting portion can be annularly continuous.
Any one or more of the first radial locking projection and\or the second radial locking projection and\or the arresting portion can be annularly segmented.
The spout engaging portion of the connector can comprise an additional projection, the projection being configured for enhancing at least one or more of coupling friction, sealing, enhancing structural strength or baring loads, in any combination thereof.
The cover and the connector can be manufactured as a unitary, integrated system, however configured for detaching one from the other.
The cover and the connector can be two separate parts, assembled to form a unitary detachably attachable system.
The cover can be assembled with the connector by screw type engagement, snap-lock arrangement, interference fit etc.
The cover can comprise a temper evident arrangement.
The container can be a bag configured to be used as a Bag-in-Box container.
The connector and the spout can be concentric.
The dispensing assembly can be fluid tight.
The displacement of the connector relative to the spout in both the first and the second coupling stages can be press fit and configured for axial introduction into one another.
The closure of the first and\or the second coupling stage can be aseptic.
The spout and the connector can comprise outwardly extending portions adapted for receiving corresponding portions of a filling machine, configured for opening and closing the first coupling engagement. Such portions are for example annularly extending projections or segments configured to be gripped by gripping arrangements of machinery associated with the filling machine.
Any one of the spout, the connector and the cover can be made of polymeric material.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A and 1B are exploded perspective view and an exploded side view, respectively, of a dispensing assembly in accordance with an example of the presently disclosed subject matter;

FIG. 2 is a perspective view of a container configured with the dispensing assembly of Fig. IA;

FIGS. 3A and 3B are a side view and a longitudinal cross section view taken along the line I-I in FIG. 3A, respectively;

FIG. 4 is an enlarged view of the arresting portion of the spout seen in FIG. 3B, marked II;

FIGS. 5A and 5B are a side view and a longitudinal cross section view taken along the line III-III in FIG. 5A, respectively;

FIGS. 6A and 6B are a side view and a longitudinal cross section view taken along the line IV-IV in FIG. 6A, respectively, with a tamper evident strip intact;

FIGS. 7A and 7B are a side view and a longitudinal cross section view taken along the line V-V, of the cover mounted over the connector seen in FIG. 7A, respectively;

FIG. 8 is an enlarged view of the portion marked VI in FIG. 7B;

FIGS. 9A and 9B are a side view and a longitudinal cross section view taken along the line VII-VII, of the connector and the cover made as a unitary article, respectively, in accordance with another example of the presently disclosed subject matter;

FIG. 10 is an enlarged detailed view marked VIII in FIG. 9B;

FIGS. 11A and 11B are a side view and a longitudinal cross section view taken along the line IX-IX, of the first coupling stage in accordance with an example of the presently disclosed subject matter;

FIG. 12 is an enlarged detailed view of a portion marked X in FIGS. 11A;

FIGS. 13A and 13B are a side view and a longitudinal cross section view, taken along the line XI-XI of the second coupling stage, respectively, in accordance with an example of the presently disclosed subject matter; and

FIG. 14 is an enlarged detailed view of a portion marked XII in FIG. 13B.

### DETAILED DESCRIPTION OF EMBODIMENTS

The presently disclosed subject matter is directed to a connector, to a cover assembly, a dispensing assembly, a container assembly comprising the connector and to a method of assembling a dispensing assembly comprising the connector.

As will be apparent from the following description, the presently disclosed subject matter is advantageous for a multi stage coupling, configured for at least two closing stages of the container, from the attachment of the dispensing assembly to the container, through the filling process of the container, until opened for use by the end user, in a reclosable fashion.

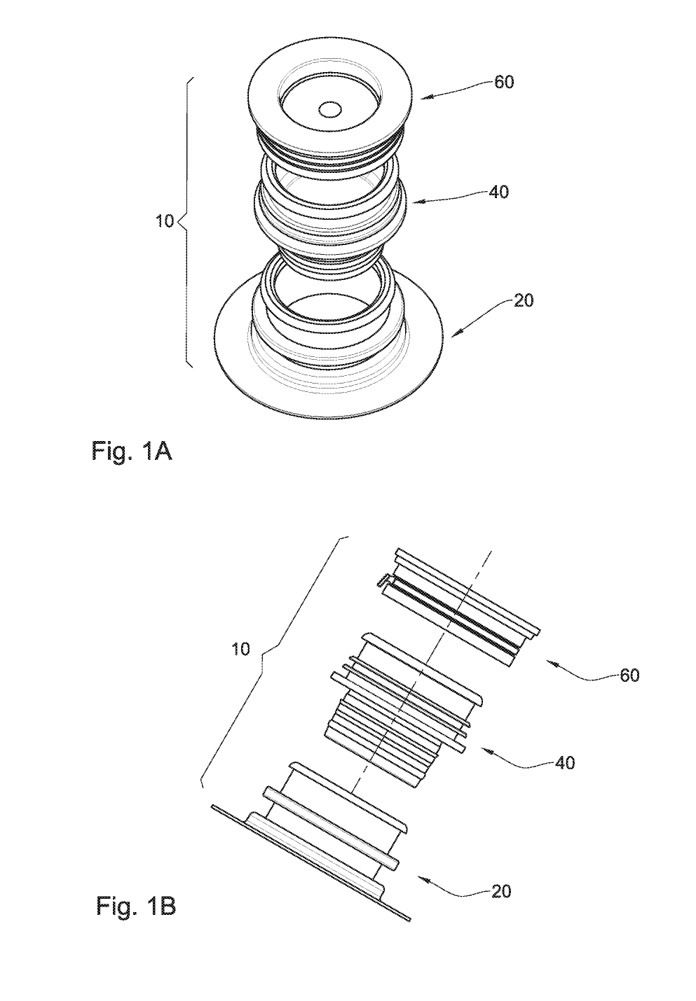

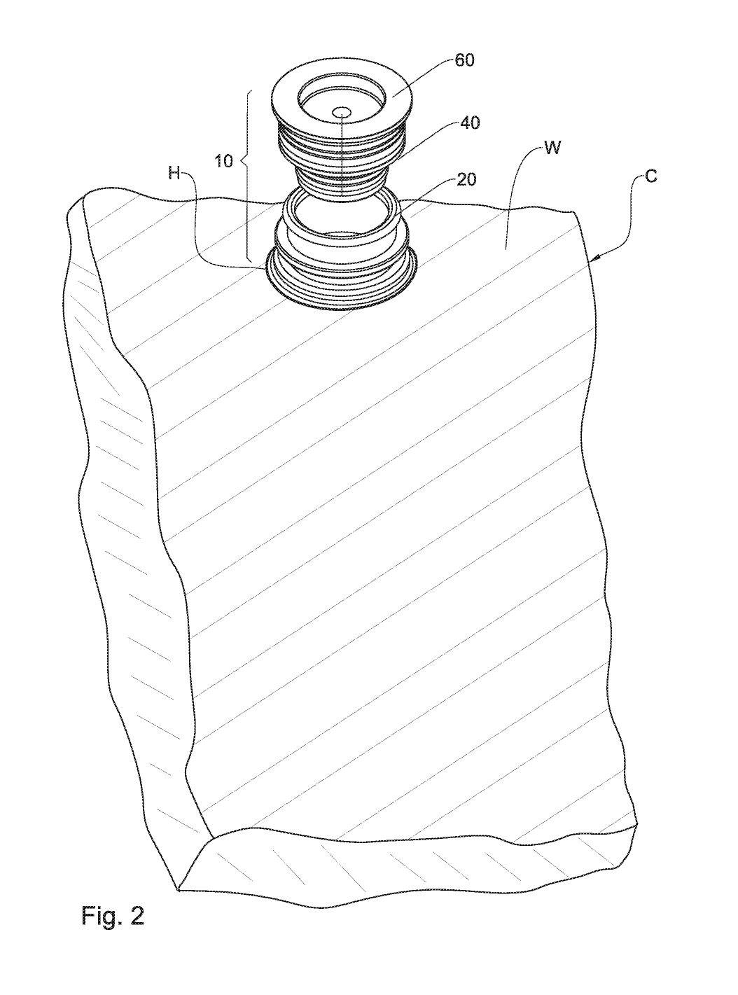

Attention is first directed to FIGS. 1A and 1B illustrating a dispensing assembly generally designated 10. The dispensing assembly according to this example comprises a spout generally designated 20, a connector generally designated 40, and a cover generally designated 60. The dispensing assembly 10 is configured for attaching to a wall W of a container generally designated C as seen in FIG. 2. In accordance with the illustrated example, the container is flexible.

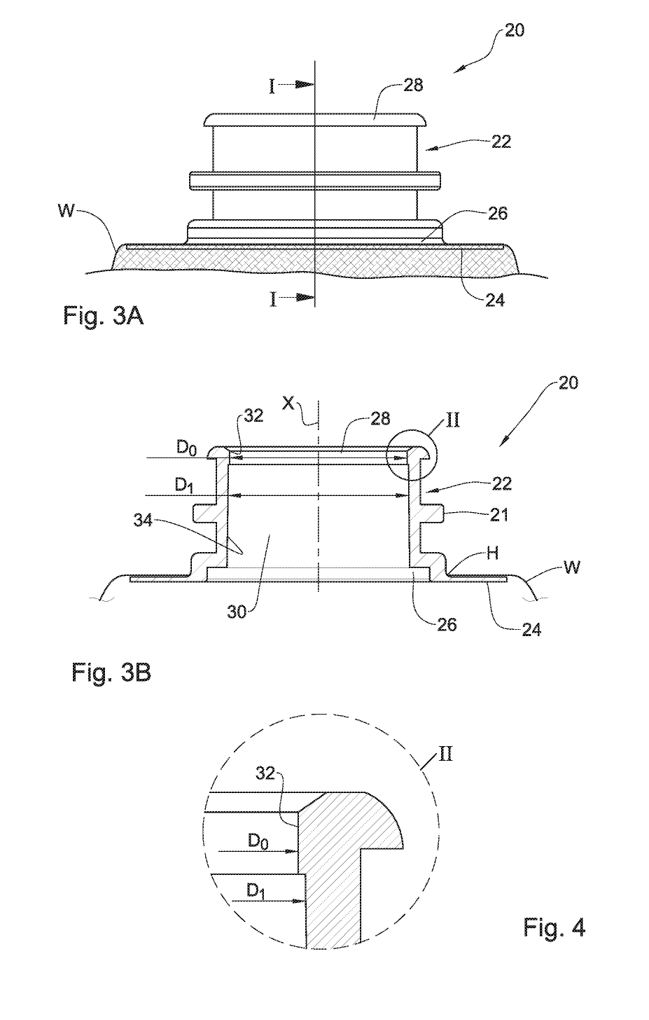

FIGS. 3A and 3B show a side view and a cross-section view, respectively, of one example of the spout 20. The spout 20 of the illustrated example has a main body generally designated 22 shaped as an annular tube, and having an inner diameter D₁, configured to extend from the container C outwardly through an opening H in the wall W of the container, shown in FIG. 2.

A laterally extending skirt like container engaging flange 24 (seen in FIG. 3B and super imposed in FIG. 3A) is extending from the main body 22 at a container engaging portion 26 of the spout 20 and having a larger outer diameter than the inner diameter of the hole H. The container engaging flange 24 is configured to be adhered or welded to the wall W, adjacent to the hole H, in a sealed fashion.

The container engaging portion 26 and a connector engaging portion 28 of the spout 20 define a passageway 30 therebetween (best seen in FIG. 3B), which is in flow communication with the inside of the container, through the hole H.

An annular arresting portion 32, shown in an enlarged view in FIG. 4, is protruding from the main body 22 at the connector engaging portion 28 of the spout 20. In the configuration demonstrated in FIGS. 3A, 3B and 4, the arresting portion 32 protrudes inwardly, having an inner diameter D₀. The arresting portion of the illustrated example is continuous annular but can also be segmented.

The spout illustrated in the drawings further comprising a flange 21, seen in FIGS. 3A and 3B, configured for gripping by a corresponding gripping portion of a filling machine, for the purpose of attaching and detaching the connector 40 from the spout 20, in the filling process of the container.

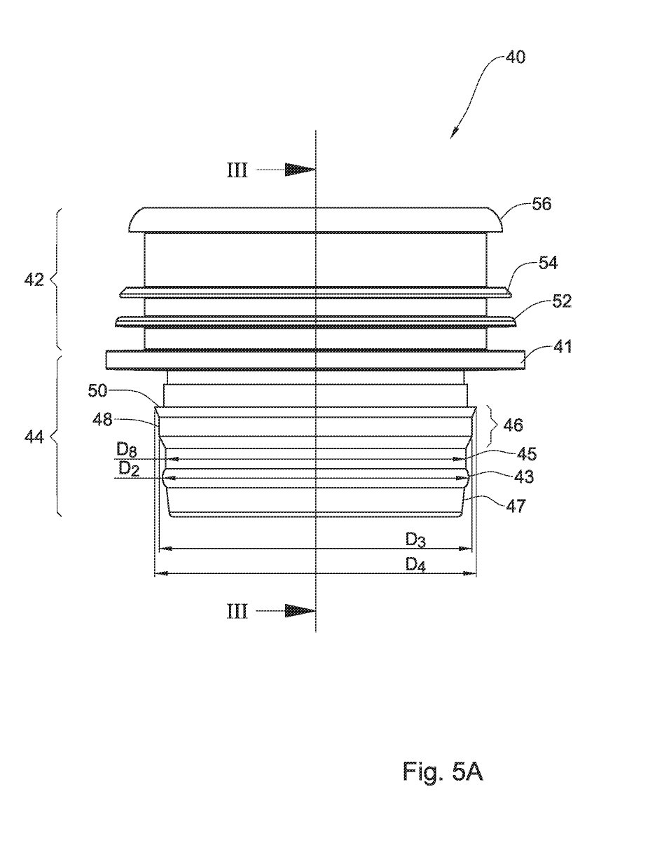

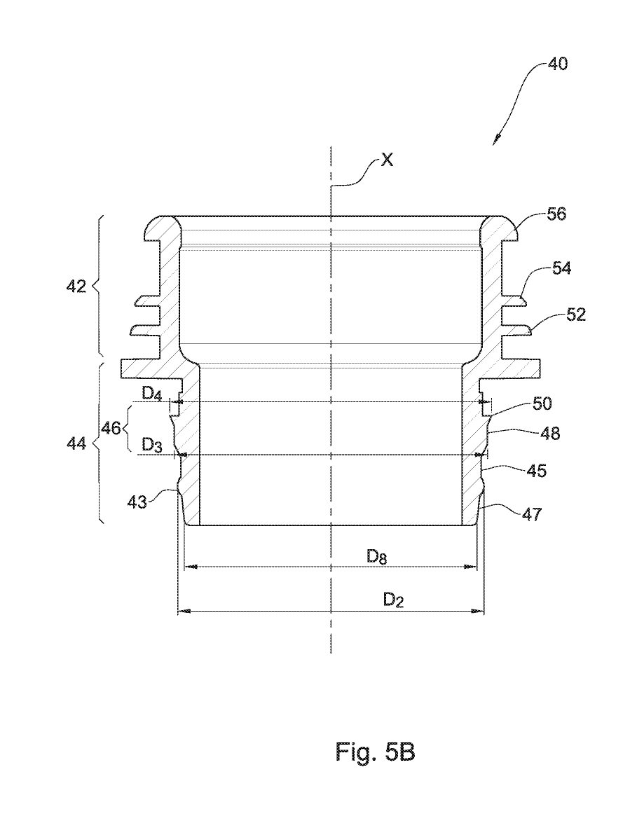

FIGS. 5A and 5B show, respectively, a side view and a cross section view of one example of the connector 40. The illustrated example of the connector 40 is generally shaped as an annular tube having a cover engaging portion generally designated 42 and a spout engaging portion generally designated 44.

The cover engaging portion 42 of the connector 40 is configured to arrest the corresponding cover 60, while the spout engaging portion 44 of the connector is configured to be attached to the spout 20.

As seen e.g. in FIG. 5A, the connector 40 is configured with an outwardly projecting locking member 46. The locking member 46 according to the illustrated example comprises two annular locking projections, a first radial locking projection 48 and a second radial locking projection 50 which protrude outwardly at the spout engaging portion 44, seen in FIG. 5A, and are configured to engage with the arresting portion 32 of the spout 20. In the illustrated example the second radial locking projection 50 protrudes laterally beyond the first radial locking projection 48 as best seen in FIG. 5B, i.e. the two projections 48 and 50 differ from each other by diameter: the second radial locking projection 50 has an outer diameter D₄ and the first radial locking projection 48 has an outer diameter D₃, with the following relation: D₄>D₃.

The spout engaging portion 44 further comprise a chamfered bottom portion 47 with an additional projection 43 extending thereabove, having an outer diameter D₂, as can be seen in FIG. 5B. A middle portion 45 is located between the additional projection 43 and the locking member 46, having an outer diameter D₈, and the following relations are maintained: D₂>D₈>D₀.

The following relations are maintained as well: D₄>D₃>D₂>D₁>D₀.

In the illustrated example the two locking projections 48 and 50 are coextensive and extend continuously one above the other without any axial interruptions and together are generally designated 46.

In another configuration, not shown in the drawings, the first radial locking projection 48 and the second radial locking projection 50 can be separate, spaced apart projections, located adjacently, and having the diameters D₄ and D₃ following the same dimensions and relations as discussed above.

The locking projections 48 and 50 of the illustrated example are continuous annular but as can be appreciated these can be annularly segmented.

The first radial locking projection 48 and the second radial locking projection 50 can be of different shapes, for example, in the example demonstrated in FIGS. 5A and 5B, the wall of the first radial locking projection 48 is flat and parallel to a longitudinal axis X of the spout while the wall of the second radial locking projection 50 extends at an angle with respect to axis X.

According to another configuration, not shown in the drawings, the arresting portion 32 of the spout can protrude outwardly from the spout 20 and the locking projections 48 and 50 of the connector 40, respectively, can protrude inwardly from the inner wall of the connector 40. In such a configuration (not shown), the outer diameter of the body 22 will be referred as D₁′, the outer diameter of the arresting portion 32 will be referred as D₀', the inner diameter of the additional projection 43 will be referred as D₂′, the inner diameter of the first radial locking projection 48 will referred as D₃′ and the inner diameter of the second radial locking projection 50 will be referred as D₄′, and the relations between them will be as follows: D₀′>D₁°>D₂′>D₃′>D₄′.

In yet another configuration, not shown in the drawings, the arresting portion 32 can be located on the spout engaging portion 44 of the connector, and the corresponding locking projections can be located on the spout with the diameters of the projections and the arresting portion being configured accordingly, mutatis mutandis.

The cover engaging portion 42 of the connector 40 is configured to receive the cover 60.

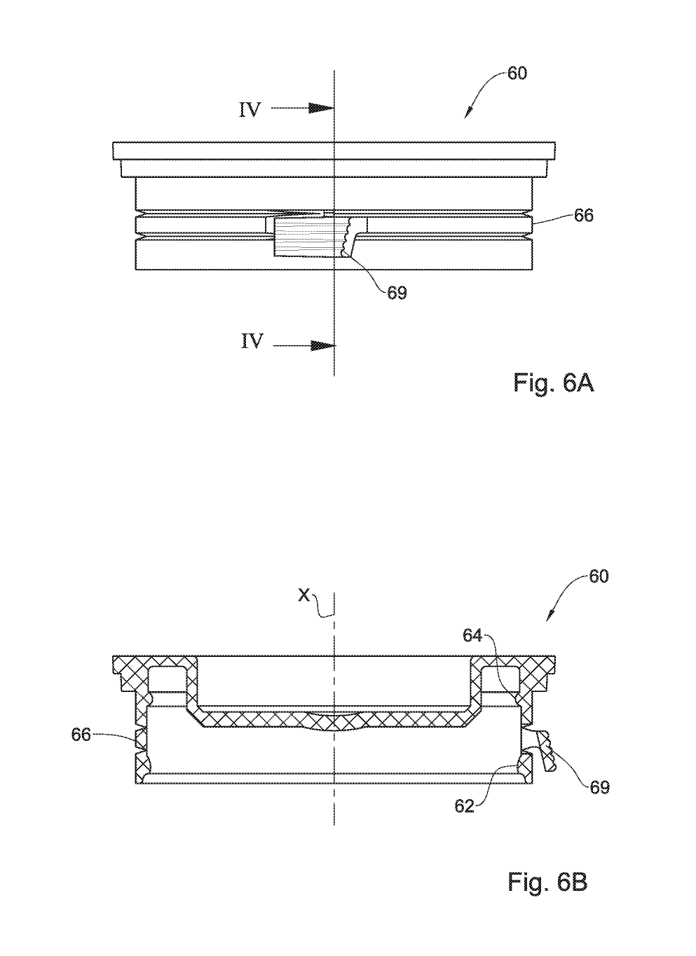

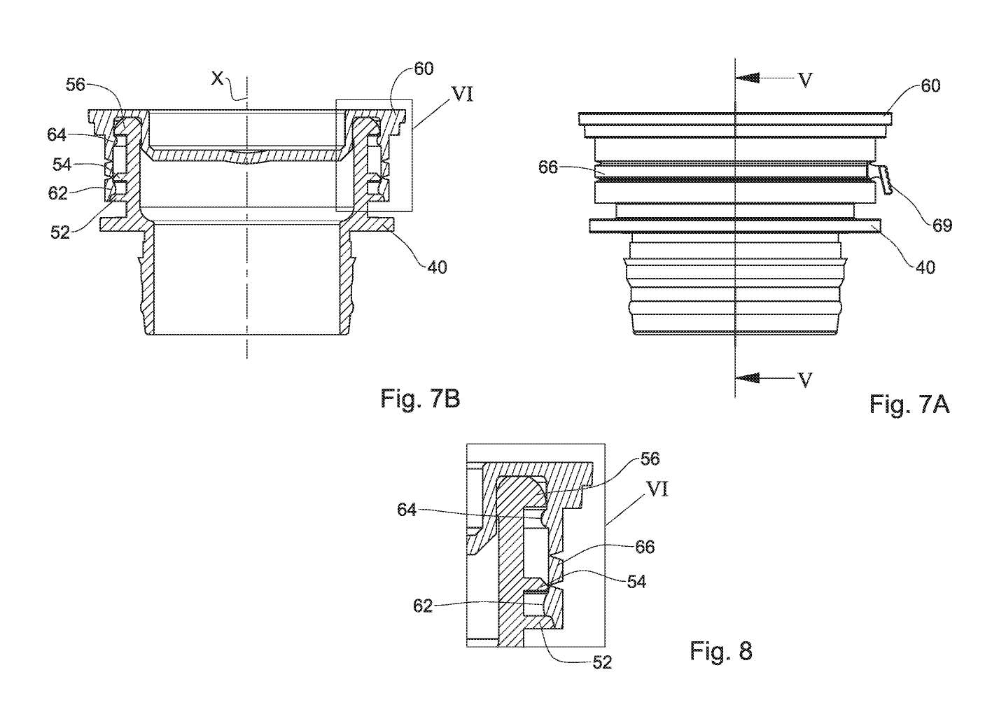

FIGS. 6A and 6B show an example of one embodiment of a cover generally designated as 60 from a side view and from a cross section view, respectively. The cover 60 is configured for cooperation with the connector 40 which in the example of 5A and 5B comprise 3 annular projections 52, 54 and 56, protruding outwardly. These projections are configured for snap engage with two projections, 62 and 64 of the cover 60, shown in FIG. 6B. An example of such engagement is demonstrated in FIGS. 7A, 7B and 8.

The cover 60 illustrated in the drawings comprises a tamper evident band 66 fitted with a pulling tab 69, which provides a proof that the cover hasn't been opened. The cover 60 is tightly attached to the connector 40 sealing it hermetically and is configured to allow re-closable opening of the dispensing assembly once the tamper evident band 66 is removed.

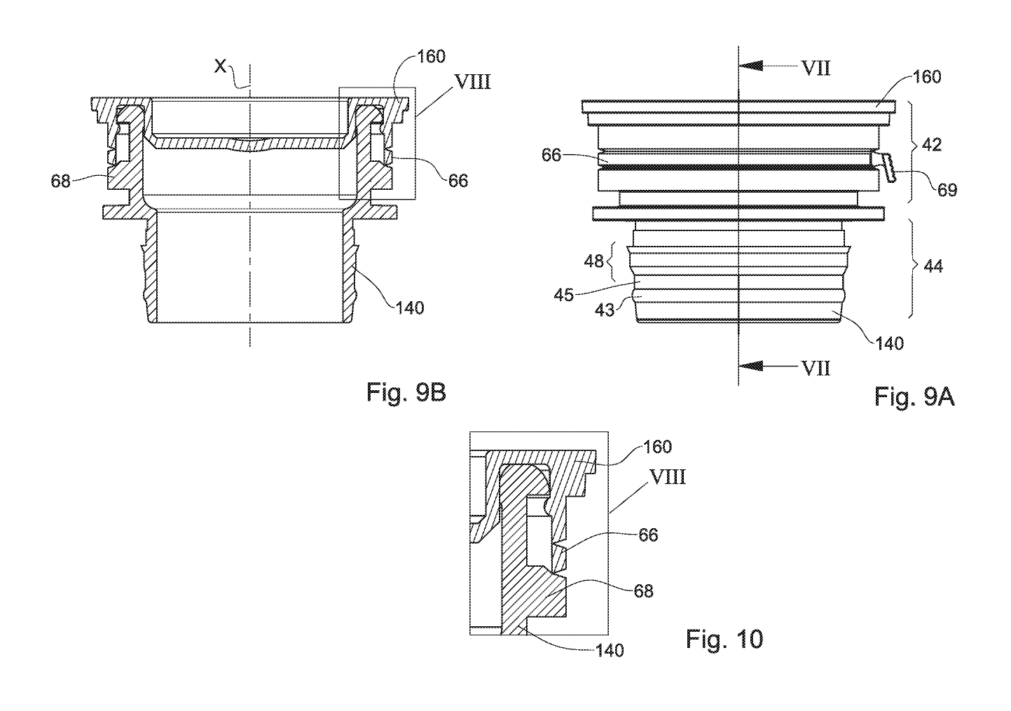

In another example, demonstrated in FIGS. 9A, 9B and 10, the cover 160 and the connector 140 can be manufactured as a unitary, integrated system, however configured for detaching one from the other, upon ripping off the tamper evident band 66.

As can be seen in FIG. 9B the connector 140 and the cover 160 are integrally formed as a single part. In the illustrated example, removing the tamper evident band 66 will allow the opening of the dispensing assembly. The enlarged view of FIG. 10 illustrates the engaging portion 68 which is common for both the cover 160 and the connector 140.

The cover 60, according to any of the embodiments, can be integrated with the connector by screw type arrangement, snap-lock arrangement, interference fit or by other mechanical arrangement.

Referring now to FIGS. 11-14, there are illustrated steps of assembling the dispensing assembly 10, according to the examples illustrated in the drawings.

It is appreciated that the parts of the assembly, i.e. the spout 20, the connector 40 and the cover 60, are made from polymeric material, which has features allowing the deformation necessary for the assembly process.

The steps of assembling are as follows:

First, a spout 20 and a connector 40 according to the presently disclosed subject matter are provided. The spout 20 is configured for attaching to the container C by welding, adhering, etc, the container engaging flange 24 of the spout to the wall W. Each one of the attachment of the spout 20 to the container C and the engagement of the connector 40 with the cover 60 can be performed at this point, prior to the following steps of assembling, or after the assembling is completed.

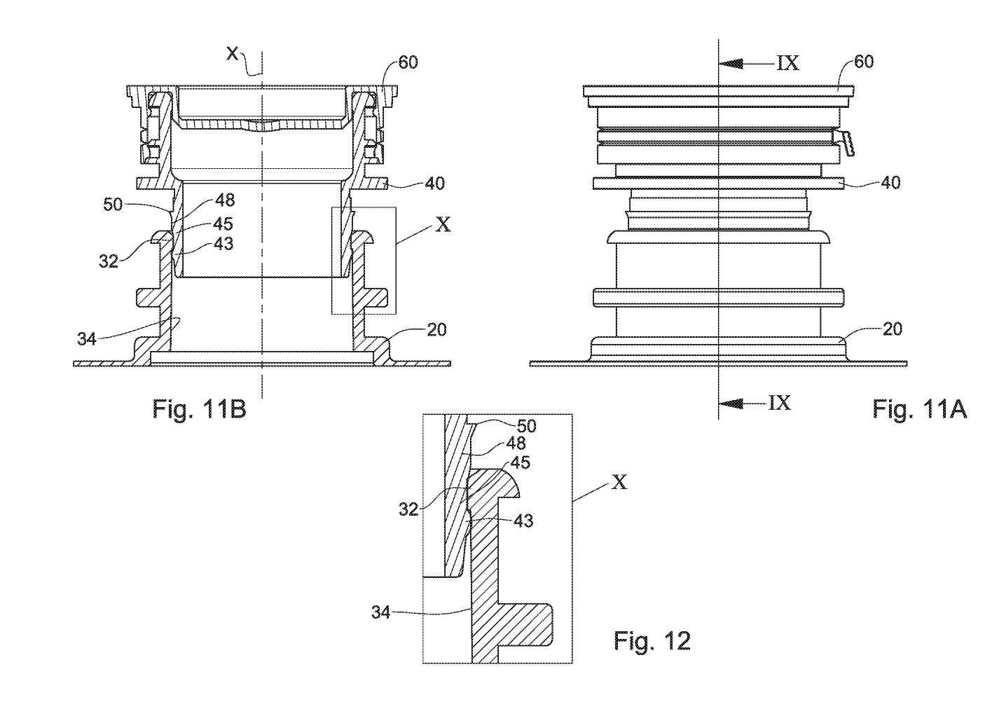

A first stage of coupling is performed during the manufacture of the container, and configured to ensure closure of the container prior to the filling process. The first coupling stage is a detachable coupling, and can be opened for the purpose of filling the container. FIGS. 11A-12 illustrate the steps of coupling at the first coupling stage.

The first coupling stage, in the embodiment illustrated in the drawings, is performed by placing the spout 20 and the connector 40 in a concentric manner relative to axis X, and pressing connector 40 towards the spout 20 in the axial direction by applying axial force in order to displace the arresting portion 32 over the additional projection 43, so as to obtain contact between the arresting portion 32 and the middle portion 45. The displacement of the arresting portion 32 over the additional projection 43 is achievable due to the features of the material forming the spout 20 and the connector 40, allowing deformation of any one or both of the arresting portion 32 and the additional projection 43 and providing a sealing arrangement therebetween. As mentioned, the relation between the inner diameter D₀ of the arresting portion 32 and the outer diameter D₈ of the middle portion 45 is as follows: D₈>D₀, and therefore, the arresting portion 32 and the middle portion 45 are pressed against each other, and an interference fit between them is achieved. Such arrangement of interference fit forms friction between the middle portion 45 and the arresting portion 32 and constituts the coupling of the first stage. The arrangement of the first coupling stage is demonstrated in FIGS. 11A, 11B and in detail view in FIG. 12.

The first radial locking projection 48, in the first stage, is located adjacent to the arresting portion 32, and is configured to prevent unintentional further displacement of the connector towards the spout, and integration of the un-openable second stage, prior to the filling process. As mentioned, the following relation is held: D₃>D₈>D₀, and therefore further movement of the connector towards the spout can be obtained only by applying intentional force.

In another configuration (not shown), the first radial locking projection 48 can operate as the member in contact with the arresting portion 32. In such a configuration, the arresting portion 32 of the spout 20 is introduced to the first radial locking projection 48 of the connector 40 in such manner that the first radial locking projection 48 and the arresting portion 32 co-extend, and are pressed against each other by means of interference fit.

As mentioned before, the following relation is held: D₃>D₀, and as a result interference fit between the arresting portion 32 and the first radial locking projection 48 is allowed. Such an arrangement of interference fit forms friction between the first radial locking projection 48 and the arresting portion 32, which constitute the coupling of the spout 20 and the connector 40, in the first coupling stage.

In both examples, the first coupling stage doesn't include a snap-lock arrangement, and is detachable.

Further illustrated in FIGS. 11B and 12 is the operation of the additional projection 43 in the first coupling stage. As can be seen best in FIG. 12, the additional projection 43 is in contact with the inner surface 34 of the connector 40. As mentioned before, the following relation is held: D₂>D₁, and therefore the contact between the additional projection 43 and the inner surface 34 of the connector 40 is achieved. This contact can enhance the sealing arrangement of the dispensing assembly, bearing pressure loads together with the locking member 46, providing additional coupling point and to function as a point of support for strengthen the structural arrangement of the first coupling stage.

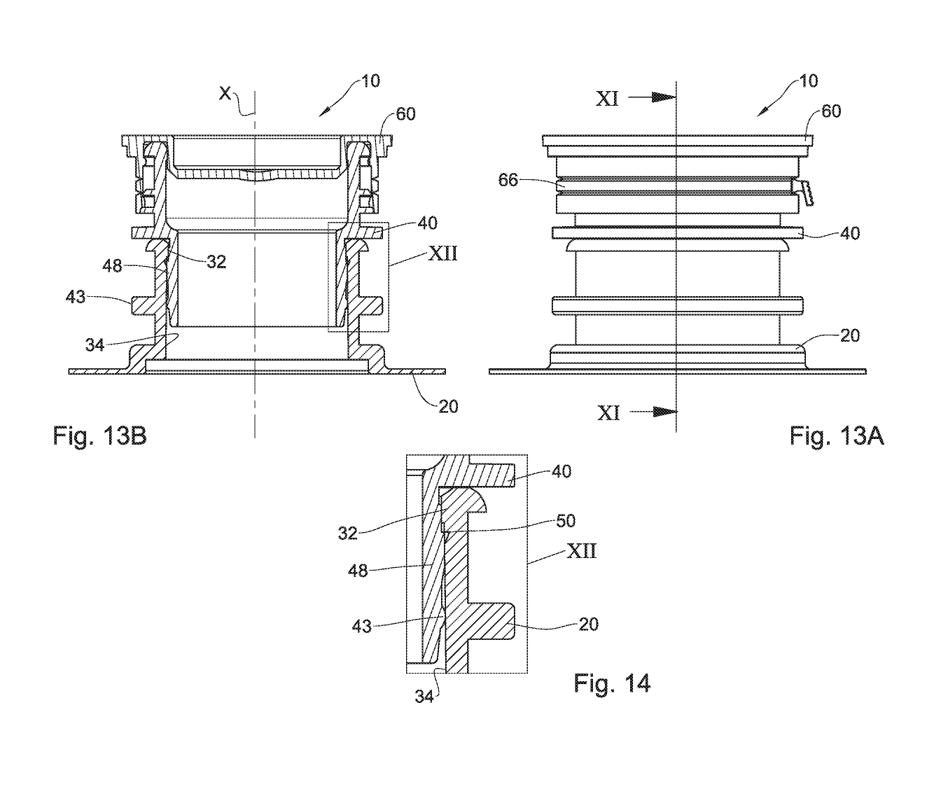

Referring now to FIGS. 13A-14, there is illustrated a second coupling stage. The second coupling stage is performed after the filling process of the container is finished, and is configured to provide a permanent, non-openable closure before providing the filled container to the end user. In this manner an aseptic closure of the container is established.

The first coupling stage is performed as a preliminary step before the second coupling stage. Then, pushing the connector 40 further towards the spout 20 so as to interlock the second radial locking projection 50 of the connector over the arresting portion 32 of the spout, in a snap-lock arrangement. The displacement of the second radial locking projection 50 over the arresting portion 32 is achievable due to the features of the material forming the spout 20 and the connector 40, allowing slight deformation of any one of the arresting portion 32 and the second radial locking projection 50. The second coupling stage is demonstrated in a side view and in a cross section view in FIGS. 13A and 13B, respectively, and in FIG. 14 in an enlarged detail view. This deformation results in tight contact between the second locking projection and the spout, such that the projection is pressed between the connector and the spout by the virtue of the forces exhibited thereupon. As best seen in FIG. 5B, the locking member 46 comprises the first radial locking projection 48 and the second radial locking projection 50. The outer wall of the first locking projection 48 extends in parallel to the corresponding portion of the inner surface 34 of the spout. The second locking projection 50 as indicated above extends at an angle to the axis X and in the exemplified projection it extends at about 90⁰, projecting beyond the locking projection 48. It will be appreciated that the angle may vary. As seen in FIG. 14 this configuration ensures the substantially full contact of the projection 48 (extending at a diameter larger than the inner diameter of the spout) with surface 34 when in the second locked position, and the exertion of pressure by the inner surface over the projection 48. As the locking projection 50 extends at a diameter larger than the inner diameter of the spout and the locking projection 48, pressure is further exerted thereon, causing its deformation and full arrestment within the spout abutted by the inner surface 34 and the arresting portion 32.

Due to the relations between the diameters, i.e. D₄>D₁ and D₂>D₁, both second radial locking projection 50 and the additional projection 43 are in contact with the inner surface 34 of the spout 20, so as to provide interference fit between both the projections, 43 and 50, and the inner surface 34, and as a result, together, taking part in sealing the second coupling stage and in the coupling between the spout 20 and the connector 40. The contact of the additional projection 43 further enhancing, as in the first coupling stage, the load bearing, and functioning as a point of support for strengthening the structural arrangement of the second coupling stage. The presence of the arresting portion 32 will further prevent the disengagement of the connector from the spout.

The displacement of the connector relative to the spout in both the first and the second coupling stages is in an axial direction, and can be obtained by applying axial force pushing the spout and the connector towards each other or by spiral displacement, such as screwing, of the connector relative to the spout.

In both the first and the second coupling stages, the dispensing assembly can be fluid tight, and can provide aseptic closure of the container, especially if used for the food industry.

Once the second engagement stage is performed, the connector and the spout are sealed and the access to the content of the container is done by removing the tamper evident band 66, and through the re-closable opening of the cover 60.

1.-25. (canceled)

26. A dispensing assembly attachable to a container, the dispensing assembly comprising:
a spout having a container engaging portion and a connector engaging portion, with a flow path extending between the two, the spout being configured for fixedly attaching to the container;
a connector, configured with a spout engaging portion and a cover engaging portion, said cover engaging portion is configured to engage with a re-closable cover;
a re-closable cover mountable over said connector;
one of said spout engaging portion and said spout comprising an arresting portion and the other of said spout engaging portion and said spout comprising a lateral projection and a locking member with an intermediate, middle portion extending therebetween, the locking member comprising a first radial locking projection and a second radial locking projection, configured for engaging with said arresting portion, in a first coupling stage wherein the lateral projection detachably engages the arresting portion and is displaced thereover so as to obtain contact therebetween and the middle portion such that the locking member engages the arresting portion and prevents further axial displacement, and a second coupling stage wherein the locking member fixedly engages the arresting portion in a non openable manner, whereby the second radial locking projection is interlocked over the arresting portion; and
wherein the second radial locking projection protrudes laterally beyond the first radial locking projection, and wherein the locking member protrudes laterally beyond the lateral projection.

27. The dispensing assembly according to claim 26, wherein the first radial locking projection and the second radial locking projection are coextensive.

28. The dispensing assembly according to claim 26, wherein the first radial locking projection and the second radial locking projection are identical or differ in any one of dimensions and shape.

29. The dispensing assembly according to claim 26, wherein the arresting portion protrudes inwardly or outwardly in the radial direction.

30. The dispensing assembly according to claim 26, wherein the first radial locking projection and the second radial locking projection protrude inwardly or outwardly in the radial direction, in the opposite direction to the arresting portion.

31. The dispensing assembly according to claim 26, wherein the spout and the connector comprise outwardly extending portions adapted for receiving corresponding portions of a filling machine, configured for opening and closing the first coupling engagement.

32. The dispensing assembly according to claim 26, wherein the cover comprises a tamper evident closure.

33. The dispensing assembly according to claim 26, wherein any one or more of the spout, the connector and the cover are made of polymeric material.

34. A connector for connecting to a spout attachable to a container, the connector is configured with a spout engaging portion and a cover engaging portion, said cover engaging portion is configured to engage with a re-closable cover, one of said spout engaging portion and said spout comprising an arresting portion, and the other of said spout engaging portion and said spout comprising a lateral projection and a locking member with an intermediate, middle portion extending therebetween, the locking member comprising a first radial locking projection and a second radial locking projection, configured for engaging with said arresting portion, in a first coupling stage wherein the lateral projection detachably engages the arresting portion and is displaced thereover so as to obtain contact therebetween and the middle portion such that the locking member engages the arresting portion and prevents further axial displacement, and a second coupling stage wherein the locking member fixedly engages the arresting portion in a non-openable manner, whereby the second radial locking projection is interlocked over the arresting portion; and wherein the second radial locking projection protrudes laterally beyond the first radial locking projection, and wherein the locking member protrudes laterally beyond the lateral projection.

35. The connector according to claim 34, wherein the first radial locking projection and the second radial locking projection are coextensive.

36. The connector according to claim 34, wherein the first radial locking projection and the second radial locking projection are identical or differ from each other in any one of dimensions and shape.

37. The connector according to claim 34, wherein the arresting portion protrudes inwardly or outwardly in the radial direction.

38. The connector according to claim 34, wherein the first radial locking projection and the second radial locking projection protrude inwardly or outwardly in the radial direction, in the opposite direction to the arresting portion.

39. The connector according to claim 34, wherein any one or more of the first radial locking projection and\or the second radial locking projection and\or the arresting portion can be annularly continuous.

40. The connector according to claim 34, wherein the cover and the connector are two separate parts assembled together.

42. The connector according to claim 40, wherein the cover is assembled with the connector by screwing, snap-lock arrangement, interference fit or other mechanical arrangement.

43. The connector according to claim 34, wherein the container is configured to be used as a bag of Bag-in-Box.

44. The connector according to claim 34, wherein the spout engaging portion of the container comprises an additional projection, configured for enhancing the sealing and coupling in the first and the second coupling stages, stabilizing the structural arrangement or baring loads, in any combination thereof.

45. A method of assembling a dispensing assembly for a container, said method comprising:
providing a container;
providing a spout, configured for fixedly attaching to the container and having a container engaging portion and a connector engaging portion, defining a flow path between the two;
providing a connector, configured with a spout engaging portion and a cover engaging portion, said cover engaging portion is configured to engage with a re-closable cover,
one of said spout engaging portion and said spout comprising an arresting portion and the other of said spout engaging portion and said spout comprising a lateral projection and a locking member with an intermediate, middle portion extending therebetween, the locking member comprising a first radial locking projection and a second radial locking projection, configured for engaging with said arresting portion, in a first coupling stage wherein the lateral projection detachably engages the arresting portion and is displaced thereover so as to obtain contact therebetween and the middle portion such that the locking member engages the arresting portion and prevents further axial displacement, and a second coupling stage wherein the locking member fixedly engages the arresting portion in a non-openable manner, whereby the second radial locking projection is interlocked over the arresting portion; and
wherein the second radial locking projection protrudes laterally beyond the first radial locking projection, and wherein the locking member protrudes laterally beyond the lateral projection.
coupling the connector with the spout in a first coupling stage, wherein the first radial locking projection detachably engages, by means of interference fit, the corresponding arresting portion, and
coupling the connector with the spout in a second coupling stage, wherein the second radial locking projection fixedly engages the corresponding arresting portion, by displacing the second radial locking projection over the arresting portion.

46. The method according to claim 45, wherein the spout and the connector are configured for receiving corresponding portions of a filling machine, configured for opening and closing the first coupling engagement.
